(19) United States
(12) Patent Application Publication
(10) Pub. No.: US 2008/0137375 A1
(43) Pub. Date: Jun. 12, 2008

(54) Light guided optical film device

(76) Inventor: Chia-Hua Chang, Taipei County (TW)

Correspondence Address: CHIA-HUA CHANG, 235 Chung - Ho, Box 8-24, Taipei, omitted

(21) Appl. No.: 11/729,575

(22) Filed: Mar. 30, 2007

(30) Foreign Application Priority Data
Dec. 8, 2006 (TW) 095145883

(51) Int. Cl. F21V 7/04

(52) U.S. Cl. 362/627

(57) ABSTRACT

An optical film device made of flexible material; the optical film having at least one optical projections or optical recesses; wherein when light emits upon the optical film; illumination of the optical projection or optical recess will different from that of the optical film. The optical film is used as a backlight source device with an optical film by adding a light source; and a metal dome sheet below the metal dome sheet. A reflecting sheet is installed below the metal dome sheet. The optical film is installed with at least one optical projection and at least one optical recess for focusing or dispersing light so as to present different illuminations. The flexible optical film is suitable for plane or non-plane structure. Moreover, the flexible optical film can uniformly distribute light by using only one light source with low power consumption.

### FIELD OF THE INVENTION

The present invention relates to backlight source devices, and particularly to a backlight source with an optical film which is made of flexible material and has at least one optical projection or at least one optical recess.

### BACKGROUND OF THE INVENTION

Generally, the backlight source of the keys 91 of the handset 90 are installed with specific light sources 92 so that the keys can light up. As shown in FIG. 1, to have suffice illumination, the number of light sources 92 is greater than 1. As illustrated in the drawing, the light sources are installed at keys 1, 3, 5, 7, 9 and 0. Other arranging ways are permissible, but the number of light sources 92 is greater than one. However, the power consumption is high, while the current trend for electronic devices is compact size and light weighted. More elements will increase the space and weight of the electronic device.

Further, since the reduction of gasoline, power saving has become an important issues. Thus if the number of light sources is reduced, power consumption will be decreased. As a result, the communication time is prolonged.

### SUMMARY OF THE INVENTION

Accordingly, the primary object of the present invention is to provide a light guided and flexible optical film. The optical film is installed with at least one optical projection and at least one optical recess for focusing or dispersing light so as to present illuminations. The flexible optical film is suitable for plane or non-plane structures. Moreover, the flexible optical film can uniformly distribute light by using only one light source with low power consumption and thus the power can be retained for a long time.

To achieve above object, the present invention provide a light guide optical film with a plurality of optical projections or a plurality of optical recesses. The optical film is made of plastics, compound resins, high molecular polymers, optical silica gel, etc., which are light guided and flexible. Furthermore the optical film of the present invention is made of the following ways. 1. The optical film is hot-pressed to form the optical recesses. 2. The optical film is screen-printed to from the optical projections. 3. Forming the optical projections or optical recesses, by molding injection or by heating the optical film, and then filling into a mold and then being cold so as to form the optical projections or optical recesses. 4. By heating melting optical silica gel into liquid, and then pouring the liquid into a mold, then products are cold, an optical film with a plurality of optical projections or optical recesses is formed. Moreover, molding injection technology can be used. When light incidents into the optical film, the light will be reflected or deflected, when the light incident to the optical projections or optical recesses, the light will be focus or dispersed so that the illumination of the optical projection or optical recess will be greater than or smaller than the illumination of the optical film. Thus the optical projection or optical recesses can be formed at a predetermined point to have a desired object.

In the present invention, a handset backlight source has a light source and a metal dome sheet which can be pressed repeatedly. The metal dome sheet is adhered below the optical film. The light source is installed at a predetermined position for illuminating the optical film so that the optical projections or optical recesses of the optical film are positioned corresponding to keys of the handset. Thus a backlight source is formed. Furthermore, a reflecting sheet is further installed below the metal dome sheet for reflecting light so that the light emitting downwards will be reflected by the reflecting sheet to incident upwards to increase the illumination of the optical film. Besides, the material of the metal dome sheet contains light reflected material, such as, polyester (PET). A plurality of metal domes are adhered at a lower side of the optical film with positions corresponding to the optical projections or optical recesses of the optical film so as to form a backlight source. Since the optical film is flexible, when the optical film is placed to the keypad of a handset, as the user presses the keys, the optical film is also pressed. Then the metal domes are also pressed so that signals can be transferred out rapidly. Since the optical film is flexible, the pressure upon the optical film will not destroy the optical film. Moreover, if the optical film is applied to a large area keypad, to have a great illumination, the illumination of the light source L can be increased.

By above mentioned backlight source, the number of light source can be reduced, but the illumination is retained, Furthermore the power consumption is reduced so as to achieve the object of power saving. The present invention has wide applications, such as telephones, keyboards, remote controllers, etc. By the present invention, the user can identify the positions of keys clearly. Moreover, the optical film can be added with dye so as to have different colors.

The various objects and advantages of the present invention will be more readily understood from the following detailed description when read in conjunction with the appended drawing.

### BRIEF DESCRIPTION OF THE DRAWINGS

FIG. 1 is a schematic view about the backlight source of a prior art keypad.

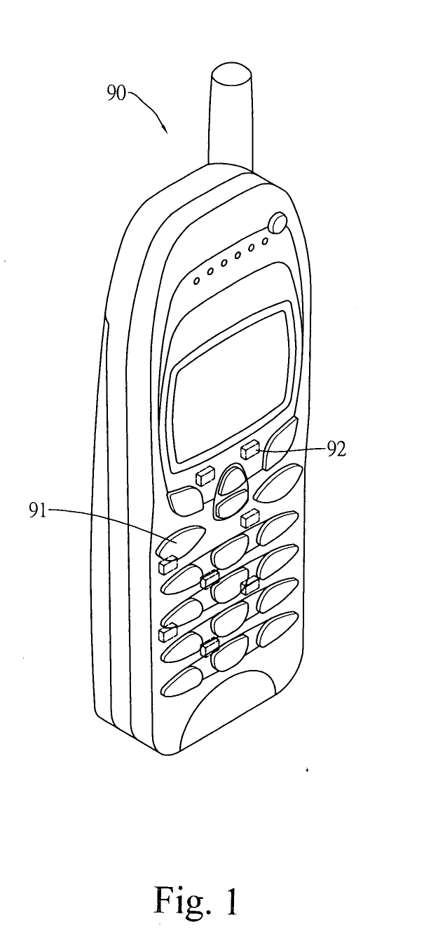

FIG. 2 is a schematic view showing the optical film with a plurality of optical projections according to the present invention.

FIG. 3 is a schematic view showing the optical film with a plurality of optical recesses according to the present invention.

FIG. 4 is a schematic view showing an application in that the present invention is applied to a backlight source device.

FIG. 5 is a schematic view showing another application in that the present invention is applied to a backlight source device.

FIG. 6 is a schematic view showing a further application in that the present invention is applied to a backlight source device.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

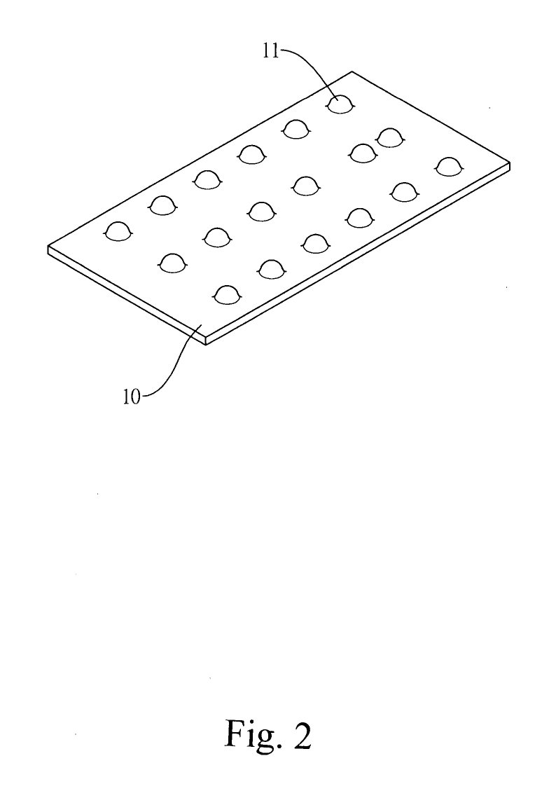

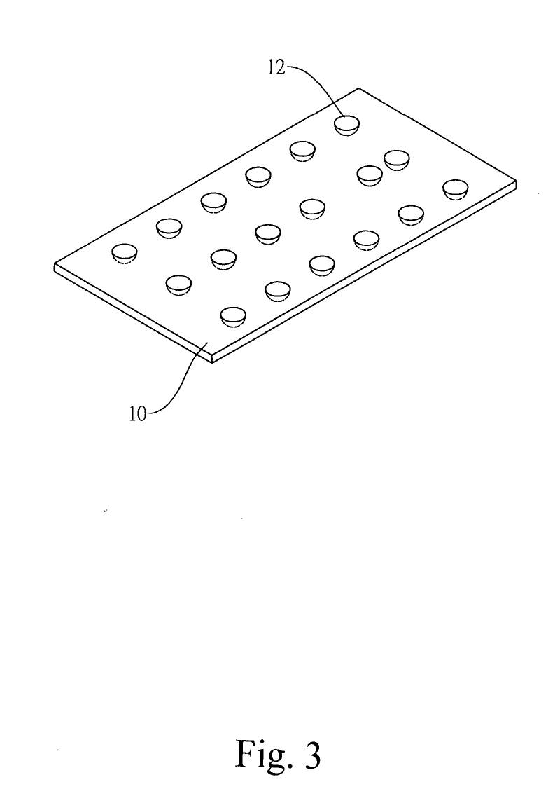

Referring to FIGS. 2 and 3, a light guide optical film 10 is formed with a plurality of optical projections 11 or a plurality of optical recesses 12. The optical film 10 is made of plastics, compound resins, high molecular polymers, optical silica gel, etc., which are light guided and flexible. Furthermore the optical film 10 of the present invention is made of the following ways. 1. Referring to FIGS. 3, the optical film 10 is hot-pressed to form the optical recesses 12. 2. The optical film 10 is screen-printed to from the optical projections 11. 3. Forming the optical projections 11 or optical recesses 12, by molding injection or by heating the optical film 10, and then filling into a mold and then being cold so as to form the optical projections 11 or optical recesses 12. 4. By heating melting optical silica gel into liquid, and then pouring the liquid into a mold, then products are cold, as illustrated in FIGS. 2 and 3, an optical film 10 with a plurality of optical projections 11 or optical recesses 12 are formed. Moreover, molding injection technology can be used. When light incidents into the optical film 10, the light will be reflected or deflected. When the light incident to the optical projections 11 or optical recesses 12, the light will be focus or dispersed so that the illumination of the optical projection 11 or optical recess 12 will be greater than or smaller than the illumination of the optical film 10. Thus the optical projection 11 or optical recesses 12 can be formed at a predetermined point to have a desired object.

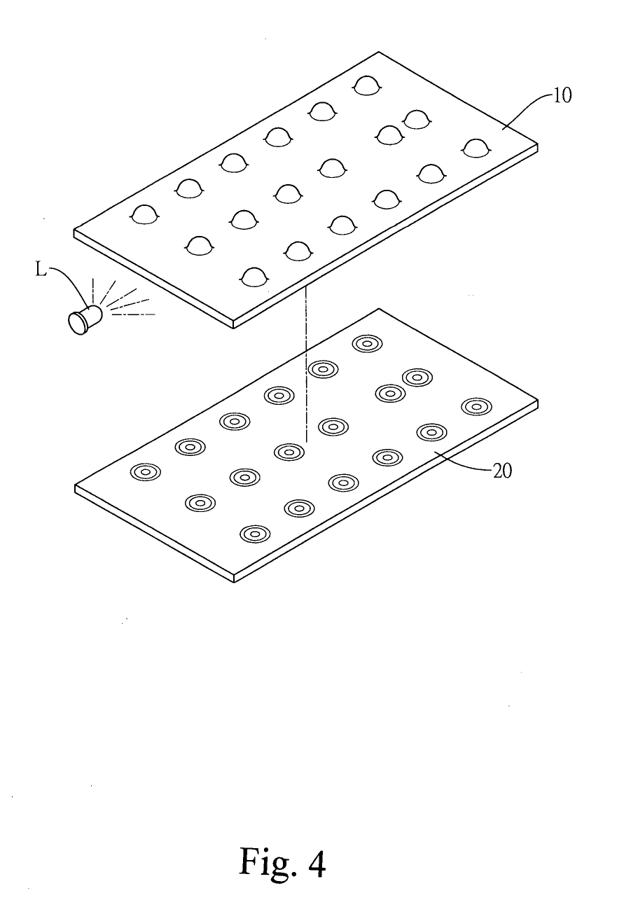

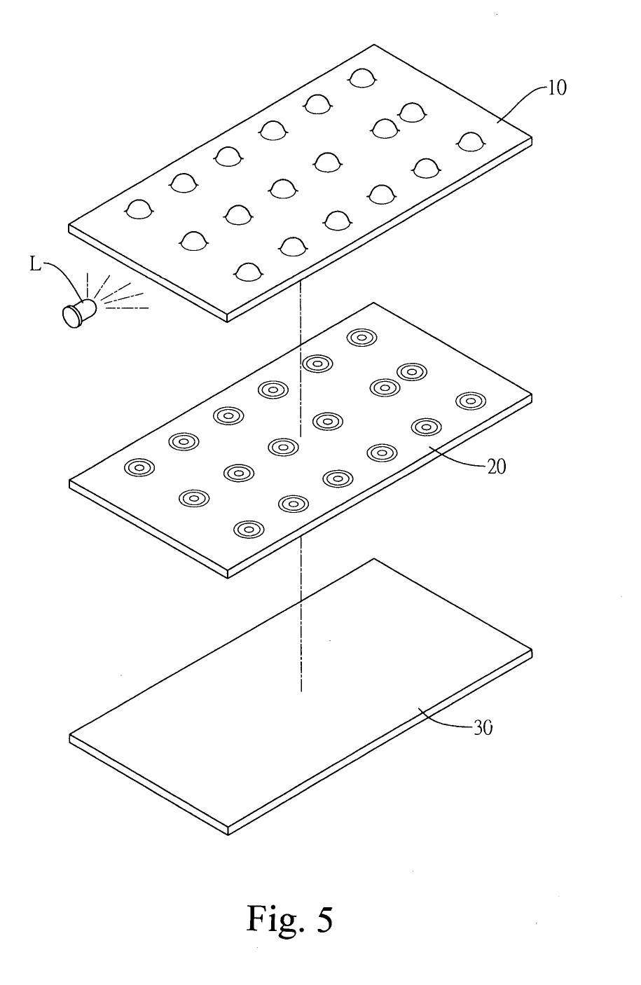

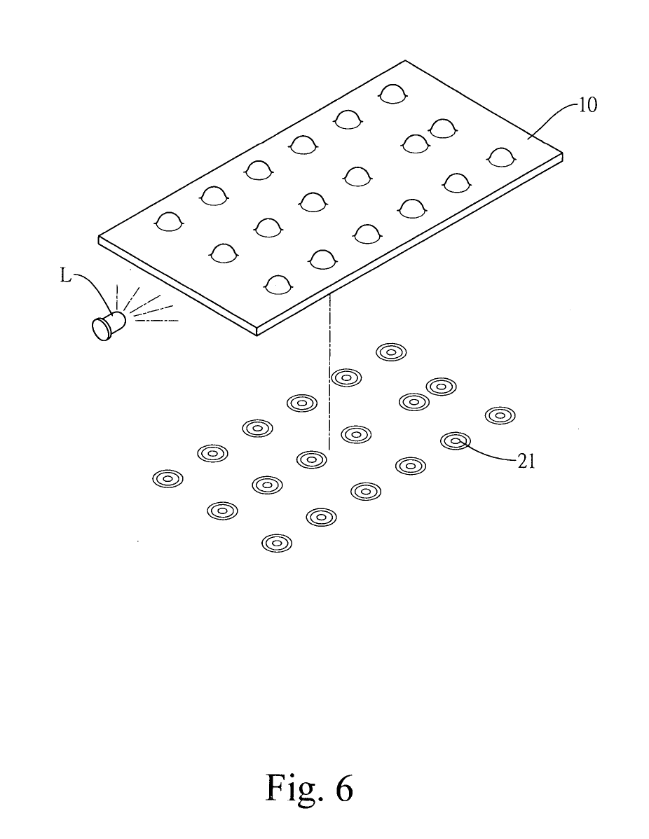

Moreover, Referring to FIG. 4, in the present invention, a handset backlight source has a light source L and a metal dome sheet 20 which can be pressed repeatedly. The metal dome sheet 20 is adhered below the optical film 10. The light source L is installed at a predetermined position for illuminating the optical film 10 so that the optical projections 11 or optical recesses 12 of the optical film 10 are positioned corresponding to keys of the handset. Thus a backlight source is formed. Furthermore as shown in FIG. 5, a reflecting sheet 30 is further installed below the metal dome sheet 20 for reflecting light so that the light emitting downwards will be reflected by the reflecting sheet 30 to incident upwards so as to increase the illumination of the optical film 10. Besides, the material of the metal dome sheet 20 contains light reflected material, such as, polyester (PET). Referring to FIG. 6, a plurality of metal domes 21 are adhered at a lower side of the optical film 10 with positions corresponding to the optical projections 11 or optical recesses 12 of the optical film 10 so as to form a backlight source. Since the optical film 10 is flexible, when the optical film 10 is placed to the keypad of a handset, as the user presses the keys, the optical film 10 is also pressed. Then the metal domes 21 are also pressed so that signals can be transferred out rapidly. Since the optical film 10 is flexible, the pressure upon the optical film 10 will not destroy the optical film 10. Moreover, if the optical film 10 is applied to a large area keypad, to have a great illumination, the illumination of the light source L can be increased.

By above mentioned backlight source, the number of light source can be reduced, but the illumination is retained, Furthermore the power consumption is reduced so as to achieve the object of power saving. The present invention has wide applications, such as telephones, keyboards, remote controllers, etc. By the present invention, the user can identify the positions of keys clearly. Moreover, the optical film 10 can be added with dye so as to have different colors.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An optical film device made of flexible material; the optical film having at least one optical projections or optical recesses; wherein when light emits upon the optical film; illumination of the optical projection or optical recess is different from that of the optical film.

2. The optical film device as claimed in claim 1, wherein the material of the optical film device is selected from one of plastics, compound resins, and high molecular polymers.

3. The optical film device as claimed in claim 2, wherein the optical film is hot-pressed to form the optical recesses.

4. The optical film device as claimed in claim 2, wherein the optical film is screen-printed to from the optical projections.

5. The optical film device as claimed in claim 4, wherein material of the optical projection is different from material of the optical film.

6. The optical film device as claimed in claim 2, wherein forming the optical projections or optical recesses is by molding injection or by heating the optical film, and then filling into a mold and then being cold so as to form the optical projections or optical recesses.

7. The optical film device as claimed in claim 1, wherein material of the optical film is silica gel.

8. The optical film device as claimed in claim 7, wherein the optical film, the optical projection and the optical recess are made by molding injection.

9. The optical film device as claim as claimed in claim 7, wherein optical silica gel is heated and melted into liquid, and then the liquid is poured into a mold, then is cold.

10. The optical film device as claimed in claim 1, wherein the optical film contains with dye.

11. A backlight source device with an optical film comprising:
a light source;
a metal dome sheet capable of being pressed repeatedly; and an optical film device made of flexible material; the optical film having at least one optical projections or optical recesses; wherein when light emits upon the optical film; illumination of the optical projection or optical recess is different from that of the optical film and
a metal dome sheet below the metal dome sheet.

12. The backlight source device as claimed in claim 11, wherein a reflecting sheet is installed below the metal dome sheet.

13. A backlight source device with an optical film comprising:
a light source;
a metal dome sheet capable of being pressed repeatedly; and an optical film device made of flexible material; the optical film having at least one optical projections or optical recesses; wherein when light emits upon the optical film; illumination of the optical projection or optical recess will different from that of the optical film and
a plurality of metal domes adhered below the metal dome sheet.
